(19) United States
(12) Patent Application Publication
(10) Pub. No.: US 2011/0170127 A1
(43) Pub. Date: Jul. 14, 2011

(54) IMAGE FORMING APPARATUS AND IMAGE FORMING SYSTEM EQUIPPED THEREWITH

(75) Inventor: Shoichi Nakamura, Tokyo (JP)

(73) Assignee: KONICA MINOLTA BUSINESS TECHNOLOGIES, INC., Tokyo (JP)

(21) Appl. No.: 12/983,979

(22) Filed: Jan. 4, 2011

(30) Foreign Application Priority Data
Jan. 9, 2010 (JP) JP2010-003458

(51) Int. Cl. G06F 3/12

(52) U.S. Cl. 358/1.13; 358/1.15

(57) ABSTRACT

An image forming apparatus includes an image forming section that forms an image based on job information, an operation section that enables an operator to conduct an input operation, and a controller that controls the image forming section, the operation section and a job, and is capable of conducting an output setting for the job. The controller causes the operation section to designate a part of pages of the job which is outputted in progress and to change the output setting.

This application is based on Japanese Patent Application No. 2010-003458 filed on Jan. 9, 2010, which is incorporated hereinto by reference.

### BACKGROUND OF THE INVENTION

The present invention relates to an image forming apparatus and an image forming system wherein image forming and post-processing are carried out based on job information including image information and output condition information.

In image forming apparatuses such as a copying machine, a printer, a facsimile machine and a multifunctional peripheral, image forming is carried out based on image information and on output condition information, and thither, post-processing such as stapling or punching is carried out when it is desired. The image information is obtained through reading of a document by a scanner or through transmission from another equipment. In the case of outputting, an output based on the aforesaid image information is carried out by ordinary output conditions established in advance, or by output conditions inputted by a preceding operator before the output through an operation section. In the case on one job, an output is carried out under the output condition established in advance. Incidentally, an output condition itself may be either the same for the whole job, or different depending on pages.

Meanwhile, there are sometimes occasions where a user wants to confirm visually whether the outputted matters outputted under the established conditions for outputting are satisfactory or not. Therefore, there has been proposed an image forming apparatus wherein it is possible to realize a confirming copy that confirms by outputting a job with one set of prints (which is sometimes called a trial print). As a result of confirming this outputted matters, when output conditions need to be changed in terms of setting, there has been proposed one that can change output conditions through operation section and can conduct the change in a page unit, a group unit and a job unit (see Unexamined Japanese Patent Application Publication No. 2006-42303). After changing output conditions, it is possible to conduct output again under the changed output conditions.

### SUMMARY OF THE INVENTION

In the aforesaid confirming copy, it is possible to conduct setting change after completion of a confirming copy, and output is conducted after this setting change.

However, there is an occasion wherein setting needs to be carried out again after misprints are discovered in ordinary outputs. In this case, setting change has been made by the following methods, in the past.

1) The job is interrupted and output is conducted again after the setting change.
2) In the case of HDD storage job, a page to be replaced is designated to be read, and setting change is carried out and the corresponded page is outputted.

However, the aforesaid method is time-consuming because it is necessary to set a job again and to indicate a print when setting is conducted again. In the above method in Item 1), many wastes are generated because all pages before the setting change are outputted.

Namely, one of aspects of an image forming apparatus of the invention has therein an image forming section that forms images based on job information, an operation section that makes operation input to be possible and a controller that controls the aforesaid image forming section and the operation section, then, controls the aforesaid job, and is capable of output setting for the aforesaid job, wherein the controller causes the aforesaid operation section to designate a part of pages and thereby to make it possible to change the aforesaid output setting.

Further, one of aspects of an image forming system of the invention is one having therein an image forming apparatus of the present invention and a post-processing apparatus that is controlled by the aforesaid control section and conducts post processing on a sheet ejected from the aforesaid image forming apparatus wherein the aforesaid output setting includes post processing in the post processing conditions in the post-processing apparatus.

The aforesaid job information has therein image information and output condition information. As the output conditions, there are given a quantity of pixels of an output image, a distinction between color and monochrome, image color adjustment, a sheet size, a direction of a sheet, a type of a sheet (a sheet type, a basis weight and a color of a sheet), selection of a sheet feed tray, a position of binding, a binding margin, existence of post-processing and post-processing conditions.

The control section is composed of CPU and a program that operates CPU, ROM that stores programs, RAM that stores data temporarily and a nonvolatile memory that stores setting data (such as a flash memory). The control section can set outputs for a job, based on the aforesaid output condition information.

The operation section is composed of a touch panel employing LCD, and it may be either one that holds also a display section or one wherein the operation section and the display section are prepared separately.

The aforesaid control section and the operation section may also be one wherein the aforesaid operations are made to be possible by an operation section of an external equipment connected to an image forming apparatus main body through LAN and by an external equipment control section equipped on an external equipment, in addition to one that is equipped on the image forming apparatus. In this case, an image forming apparatus controlling section that is equipped on the image forming apparatus main body to control the image forming section and the aforesaid external equipment control section work together to function as a control section of the present invention.

A change of output setting can be made by an operator through an operation section. In the control section, the operation section makes the output setting change to be possible during a job. Therefore, when the operation section is composed of a touch panel, an operation input is made to be possible by displaying a button that makes it possible to select an output setting change. In the control section, when the output setting change is selected through the operation section, control procedures for changing output setting are caned out.

In the control section, it is either possible to make operation input concerning further output setting change to be possible by interrupting a job in the case of outputting when changing output setting change, or possible to make operation input concerning further output setting change to be possible by continuing output. In the case of changing output setting, it is possible to determine whether interrupting temporarily or continuing a job, based on operation conditions established in advance. The operation conditions may also be those wherein a change can be made by an operator, and the aforesaid determination is made under the operation condition after the selection in operations thereafter.

Further, in the case of changing output setting, it is also possible to arrange so that an operator can select interrupting temporarily a job, or continuing a job, in the case of the aforesaid output setting change. In this case, in the control section, the operation section is controlled so that either one of interrupting and continuing a job can be selected. On the touch panel, a button that conducts selection is displayed in a way so that an operation input is possible.

After the change of output setting is made, the corresponding page thus changed is outputted under the output condition after the change by the control section after the change of output setting.

Incidentally, an output method after output setting change may either be one that is based on conditions established in advance or be one that is based on conditions established by an operator in the case of the aforesaid change of output setting chance. Through the output method, output is carried out by the control section. As the output method, there are given the following methods.

As one of them, it is also possible to output residual number of sets of jobs according to the number of sets by skipping output of the changed corresponding page, after the change of the output setting, and to output the established number of sets for the changed corresponding page collectively.

In the aforesaid output method, it is possible to avoid that waste is outputted after the change of output setting, and it is possible to regulate easily for outputted matters like adding to changed pages, because changed pages are outputted collectively.

As another outputting method, it is possible to output residual number of sets of jobs after the change of the aforesaid output setting, by replacing them with the changed corresponding pages, and to output collectively after outputting the established number of sets of the aforesaid jobs, for the corresponding pages outputted by the time of the change of the aforesaid output setting.

Even by the aforesaid output method, it is possible to avoid that waste is outputted after the change of output setting, and it is possible to regulate easily for outputted matters like adding to changed pages, because changed pages are outputted collectively. Further, after the change of the output setting, remaining number of sets are outputted by replaced with the corresponding pages which have been changed in terms of output changing, thus, with respect to outputted matters before that time, only pages changed in case of need have only to be replaced, which makes regulating to be easy.

Further, as a method of outputting after the change of setting change sheet-ejecting destination can be controlled by the control section.

In one of methods to control sheet-ejection destinations, a page on which the aforesaid output setting change has been made is outputted to a tray that is different from that in the outputted text, after the change of the aforesaid output setting. In this method, pages subjected to output setting change are discriminated from other outputted matters finally when they are outputted collectively, which makes handling to be easy. The pages to be outputted collectively appear in the case of whole pages which have subjected to output setting change as mentioned above, and those appear in the case of corresponding pages after changes of output setting.

Further, as another control method for sheet-ejection destination, there is given a method wherein remains of the jobs are outputted to a tray different from that in the outputted text by the aforesaid setting change, after the change of the aforesaid output setting.

Owing to this, it is possible to distinguish outputted matters including pages before setting change from outputted matters including no pages before setting change. In this case, if three or more trays are equipped, pages subjected to output setting change can further be ejected to another tray.

### BRIEF DESCRIPTION OF THE DRAWINGS

FIG. 1 is a diagram showing a mechanical structure of the whole image forming apparatus representing an embodiment of the invention.

FIG. 2 is a diagram showing an electric block structure representing an embodiment of the invention.

FIG. 3 is an image diagram showing a job list on RAM representing an embodiment of the invention.

FIG. 4 is an image diagram showing job information on compression memory representing an embodiment of the invention.

FIG. 5 is a display image screen wherein an output setting change in an operation section can be selected, representing an embodiment of the invention.

FIG. 6 is a diagram showing a page input screen in output setting change in an operation section, representing an embodiment of the invention.

FIG. 7 is a diagram showing an output setting change in an operation section, representing an embodiment of the invention.

FIG. 8 is a diagram showing a binding margin setting screen as a detailed output setting change screen in an operation section, representing an embodiment of the invention.

FIG. 9 is a diagram showing a binding margin setting screen as a detailed output setting change screen in an operation section, representing an embodiment of the invention.

Each of FIGS. 10A to 10C is a schematic diagram showing an example of an output method after the output setting change, representing an embodiment of the invention.

FIG. 11 is a flow chart showing procedures including output continuation or output interruption in the case of output setting change, representing an embodiment of the invention.

FIG. 12 is a flow chart showing main procedures that output finally collectively by skipping the corresponding page after output setting change, representing an embodiment of the invention.

FIG. 13 is a flow chart showing procedures that checks a page subjected to output setting change, representing an embodiment of the invention.

FIG. 14 is a flow chart showing procedures that output collectively finally, representing an embodiment of the invention.

FIG. 15 is a flow chart showing main procedures that output the corresponding pages before the output setting change collectively finally, by replacing the corresponding pages after output setting change, representing an embodiment of the invention.

FIG. 16 is a flow chart showing procedures that output collectively finally, representing an embodiment of the invention.

### DETAILED DESCRIPTION OF THE PREFERRED EMBODIMENT

An embodiment of the invention is explained in detail as follows.

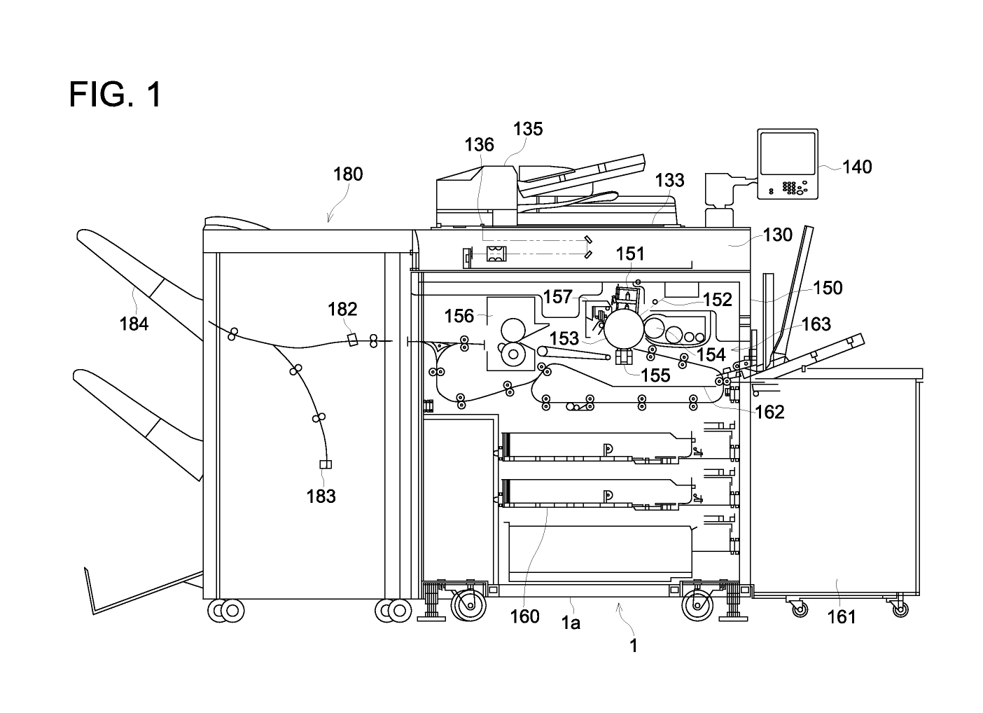

FIG. 1 is a diagram showing a mechanical structure of an image forming apparatus 1 representing an embodiment of the invention and an image forming system including the image forming apparatus 1, and its explanation will be given as follows.

The image forming apparatus 1 is a digital multifunctional peripheral having functions of a printer, a scanner and a copying machine, and on the upper side of image forming apparatus main body 1a on which the respective functions of the multifunctional peripheral are stored in a casing and are provided, there are provided scanner section 130, platen glass 133 on which a document is placed, automatic document feeder (ADF) 135 and slit glass 136 that reads ADF document reading a document sent from the automatic document feeding device (ADF) 135. In the vicinity of the aforesaid items, there is provided operation section 140 that can display information and further can input various types of operations. In the present embodiment, image forming apparatus main body 1a corresponds to the image forming apparatus 1. However, the present invention may also be one wherein the image forming apparatus is composed of the image forming apparatus main body 1a and of external equipment existing outside the image forming apparatus main body 1a.

Further, on the bottom side of the image forming apparatus main body 1a, sheet feed trays (1 to 3) 160 of plural steps which store sheets and feed sheets are provided, and further, and large capacity sheet feed tray 161 is equipped on the outer side of the image forming apparatus main body 1a. To these sheet feed tray 160 and the large capacity sheet feed tray 161, there are connected a sheet feed roller, a conveyance roller, second sheet feed roller 162 and conveyance section 163 including a conveyance path, and the second sheet feed roller 162 feeds out to the image forming (transfer) position at prescribed timing.

Further, printer section 150 provided inside the image forming apparatus main body 1a is composed mainly of the aforesaid conveyance section and of the image forming section. The image forming section is equipped with electrification section 151, LD (laser diode) 152, photoconductor 153, developing section 154, transfer section 155, fixing section 156 and cleaning section 157. Further, the aforesaid conveyance section 163 that conveys a sheet on which an image has been formed is extended on the downstream side of the printer section 150. On the downstream side of the conveyance section 163, there is connected sheet finisher (FNS) 180. The image forming system of the invention is composed of the aforesaid image forming apparatus 1 and the sheet finisher (FNS) 180.

The printer section 150 charges evenly on the surface of photoconductor 153 with the electrification section 151, and then, it forms a latent image by conducting exposure scanning based on image information with a laser beam of LD 152, and forms a toner image on the surface of the photoconductor 153 by carrying out reversal development for the latent image with the developing section 154.

A sheet fed from sheet feed tray 160 or from large capacity sheet feed tray 161 is sent to a transfer position by the conveyance section 163. In this case, the sheet is fed out to an image forming (transferring) position at a prescribed timing by second sheet feed roller 162. On the transfer position, a toner image is transferred by transfer section 155. After that, the sheet on which an image has been formed is conveyed by conveyance section 163, then, is heated and fixed in the fixing section 156, and is conveyed to sheet finisher 180.

After the transferring, the photoconductor 153 is cleaned by cleaning section 157 so that residual developer staying on the surface of the photoconductor 153 may be removed, to be ready for the next image forming.

The sheet finisher (FNS) 180 to which the sheet on which an image has been formed is conveyed is equipped with punch unit 182 that punches the sheet and with stapler 183 that staples sheets, and further, it has plural sheet-ejection frays 184 to which the sheets which have been subjected to post processing or which have not been subjected to post processing are ejected.

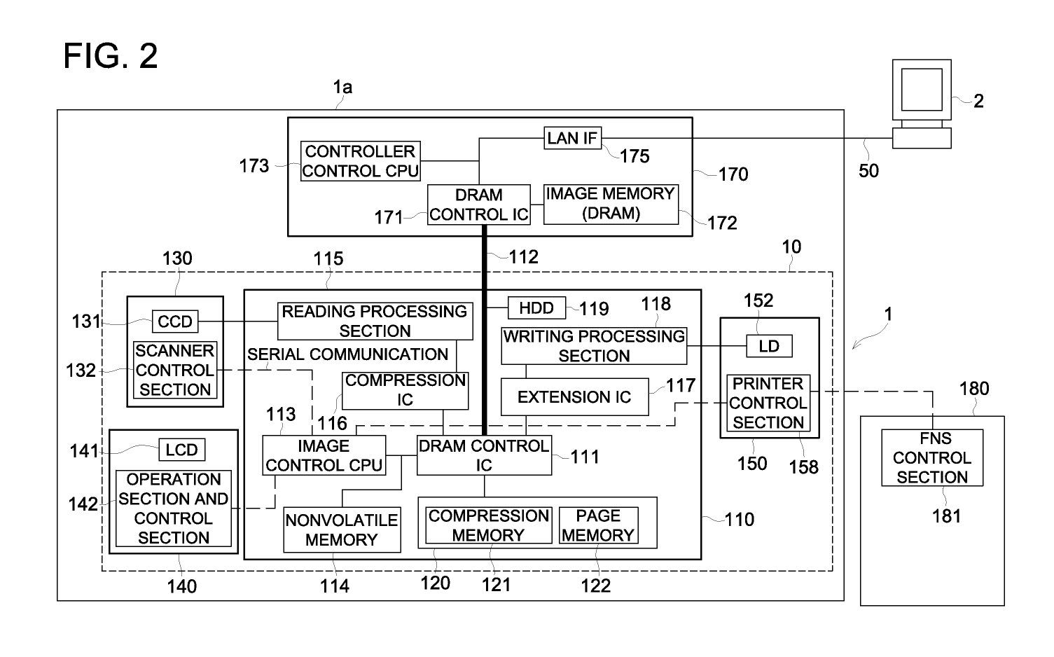

Next, FIG. 2 is a block diagram showing an electric block structure of an image forming apparatus in the present embodiment of the invention, which will be explained as follows.

The image forming apparatus main body 1a is composed mainly of digital copier main body 10 having therein image control section 110, scanner section 130, operation section 140 and printer section 150, and of image processing section (print & scanner controller) 170. Further, with respect to the image forming apparatus main body 1a, the aforesaid image control section 110 is connected to LAN 50 through LAN interface 175, so that access from external equipment 2 is possible.

The image control section 110 has PCI bus 112, and the PCI bus 112 is connected to DRAM control IC 111 in the image control section 110. Further, the image control section 110 is equipped with image control CPU 113, and the aforesaid DRAM control IC 111 is connected to the image control CPU 113. Nonvolatile memory 114 is connected to image control CPU 113, and the image control CPU 113 is further equipped with unillustrated RAM or ROM. In the aforesaid nonvolatile memory 114, there are stored a program for operating the aforesaid image control CPU 113, established data for image forming apparatus 1, process control parameter and established data for job interruption and job continuation in the case of conducting setting change in the course of job outputting.

The image control CPU 113 is one to control the whole image forming apparatus 1 and to conduct state grasping for the whole image forming apparatus 1, and it further conducts an inauguration of a job, an interruption and an action control. Namely, the image control CPU 113 functions as a control section together with nonvolatile memory 114.

The aforesaid scanner section 130 is equipped with CCD 131 that practices optical reading and is equipped with scanner control section 132 that practices control of the whole scanner section 130. The scanner control section 132 is connected with the aforesaid image control CPU 113 to be capable of conducting serial communication, and it receives control that is made by image control CPU 113. Incidentally, the scanner control section 132 can be composed of CPU and of a program that causes CPU to operate. Image information acquired through reading by the CCD 131 is processed in readout processing section 115 by readout processing section 115. To readout processing section 115, there is connected compression IC 116 that compresses image information, and the compression IC 116 is connected to the aforesaid DRAM control IC 111.

The aforesaid operation section 140 is equipped with LCD 141 of a touch panel type and with operation control section 142, and the LCD 141 and the operation control section 142 are connected each other, and the operation control section 142 is connected to the image control CPU 113 to be capable of serial communication. The control for operation section 140 is made by image control CPU 113 in the aforesaid structure, and input information of the control for operation section 140 is sent to the image control CPU 113. Incidentally, the operation control section 142 can be composed of CPU and of a program that causes CPU to operate. In the operation section 140, an input of action control conditions such as setting in the image forming apparatus and action instructions is made to be possible, and further, contents of establishment, machine conditions and display of information are made to be possible, and they are controlled by the aforesaid image control CPU 113.

Further, the DRAM control IC 111 is connected to image memory 120 that is composed of compression memory 121 and of page memory 122. In the image memory 120, image information obtained through the scanner section 130 and image information obtained through LAN 50 are stored. As stated above, image memory 120 is a memory area for image information, and it stores image information for jobs to be printed. Further, HDD 119 is connected to PCI bus, and image information obtained by scanner section 130 and image information generated by external equipment 2 connected to image processing device (print and scanner controller) 170 are preserved in the HDD 119.

Further, extension IC 117 that extends compressed image information is connected to DRAM control IC 111, and writing processing section 118 is connected to the extension IC 117. The writing processing section 118 is connected to LD 152 of printer section 150, to process the data used for actions of the LD 152. Further, the printer section is equipped with printer control section 158 that controls the whole printer section 150, and the printer control section 158 is connected to the aforesaid image control CPU 113 to receive the control. Namely, it conducts a start and stopping of print operations based on parameters given by image control IC 113. Further, it notifies the state of equipment for printer section 150 to image control CPU 113. Further, sheet finisher control section (FNS control section) 181 that is equipped on sheet finisher 180 is connected to the printer control section 158. Owing to this, the sheet finisher 180 can be controlled by the image control CPU 113 through the printer control section 158 and the sheet finisher control section 181. The state of the apparatus of the post-processing apparatus 180 is outputted by image control CPU 113 through the post-processing control section 181 and printer control section 158.

Incidentally, each of the printer control section 158 and the sheet finisher control section 181 can be composed of CPU and of a program that causes the CPU to operate.

Furthermore, DRAM control IC 171 of the aforesaid image processing device (print and scanner controller) 170 is connected to the aforesaid PCI bus 112 connected to the DRAM control IC 111. In the aforesaid image processing device (print and scanner controller) 170, image memory 172 is connected to the DRAM control IC 171. Further, in the image processing device (print and scanner controller) 170, controller control CPU 173 is connected to the DRAM control IC 171, and LAN interface 175 is connected to the DRAM control IC 171. The LAN interface 175 is connected to the aforesaid LAN 50.

Next, basic operations of the aforesaid image forming apparatus 1 will be explained.

First, procedures to accumulate image information in the image forming apparatus 1 will be explained.

When generating image information by reading images of a document with scanner section 130 in the image forming apparatus 1 first, the images of a document are read optically by CCD 131 in the scanner section 130. In this case, operations of the CCD 131 are controlled by scanner control section 132 that receives instructions from image control CPU 113.

Images which have been read by CCD 131 are subjected to data processing in readout processing section 115, then, the image information subjected to data processing is compressed by a prescribed method in compression IC 116, to be stored in compression memory 121 through DRAM control IC 111. The image information stored in the compression memory 121 can be controlled by image control CPU 113 as a job. When storing in HDD 119, data stored in the compression memory 121 temporarily are sent to HDD 119 through DRAM control IC 111.

When acquiring image information from the outside, job information to be sent from external equipment 2 through LAN 50, for example, is stored in image memory 172 by DRAM control IC 171 through LAN interface 175. Data of image memory 172 are stored in page memory 122 temporarily through DRAM control IC 171, PCI bus 112 and DRAM control IC 111. Data stored in the page memory 122 are sent to compression IC 116 in order to be compressed through DRAM control IC 111, and are stored in compression memory 121 through DRAM control IC 111, and are controlled by image control CPU 113 in the same way as that mentioned above. Further, when storing in HDD 119, data stored temporarily in compression memory 121 are sent to HDD 119 through DRAM control IC 111.

When outputting images on image forming apparatus 1, namely, when an equipment is used as a copying machine or a printer, and when data stored in HDD 119 are used, the data are stored temporarily in compression memory 121 through DRAM control IC 111. Job information including image information stored in compression memory 121 is sent to extension IC 117 through DRAM control IC 111 so that data are extended, then, the extended data are sent to writing processing section 118, and writing on photoconductor 153 is practiced in LD 152. Furthermore, in printer section 150, instructions of image control IC 113 are received, and printer control section 158 controls respective portions, and transfer onto a prescribed sheet (unillustrated) is carried out by transfer section 155 and fixing is conducted by fixing section 156. The sheet on which an image has been formed is conveyed to sheet finisher 180 through conveyance section 163, and when there is designation for post-processing, the post-processing is conducted on the sheet as stated above, and when the post-processing is not needed, the sheet is ejected as it is to sheet-ejection tray 184.

Meanwhile, in the case of image output, outputting is carried out based on job information on image control CPU 113. The job information includes output condition information in addition to the aforesaid image information. Output conditions are composed of information including a print mode, a tray, a sheet ejection destination and post-processing conditions, and there are given specifically a quantity of pixels of output images, a distinction between color and monochrome, tone adjustment, a sheet size, a sheet direction, a sheet type (sheet type, basis weight and a sheet color), a selection of sheet tray, a binding position, a binding margin, presence or absence of post-processing and post-processing conditions.

For output conditions, standard setting is determined in advance as an initial setting, and the initial setting is stored in nonvolatile memory 114. The initial setting is read out by image control CPU 113 in case of need, and it is stored in image memory 120 and HDD 119 as job information, together with image information.

Output conditions can be established at operation section 140. When obtaining image information, operation control section 142 is controlled by image control CPU 113, and a screen capable of inputting output setting is displayed on LCD 141. When an appropriate operation is inputted by an operator, pieces of information such as output conditions established on the operation section 140 (print mode, tray and sheet ejection destination) are notified from operation control section 142 to image control CPU 113. On the image control CPU 113, output condition information is prepared, and it is stored in a memory equipped on the image control CPU 113 temporarily. When image information is obtained, it is stored in image memory 120 or in HDD 119 as job information together with image information. Ordinary printing and designation of confirmation copy are conducted in this procedure.

When using image forming apparatus 1 as a printer by obtaining image information from the outside, establishment can be caned out by a printer driver of external equipment 2. Therefore, in this case, an operation section that establishes output conditions is equipped on external equipment 2, and the control for the operation section is conducted by an external equipment control section (unillustrated) equipped on external equipment 2. The output condition information established by external equipment 2 is sent to image forming apparatus 1 as job information together with image information. Namely, according to FIG. 2, the job information is stored in image memory 172 from external equipment 2 through LAN 50 and LAN interface 175, and then, is stored in page memory 122 by DRAM control IC 171 and DRAM control IC 111.

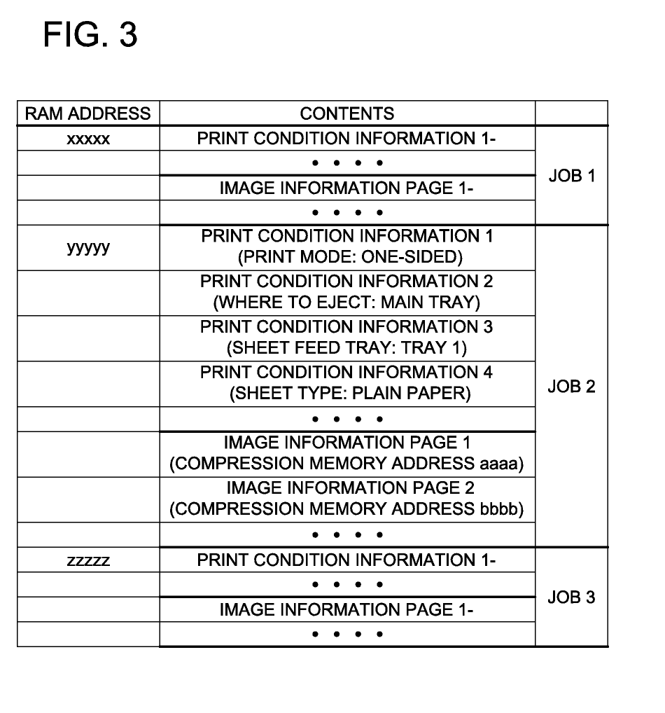

Output condition information and image information are brought into connection with each other, and they are stored as a job list in RAM included in image control CPU 113. FIG. 3 is one showing an outline of the job information on RAM, and print conditions and memory addresses of image information in compression memory 121 are stored. Incidentally, job information stored in compression memory 121 is composed of a header including print conditions and of image information.

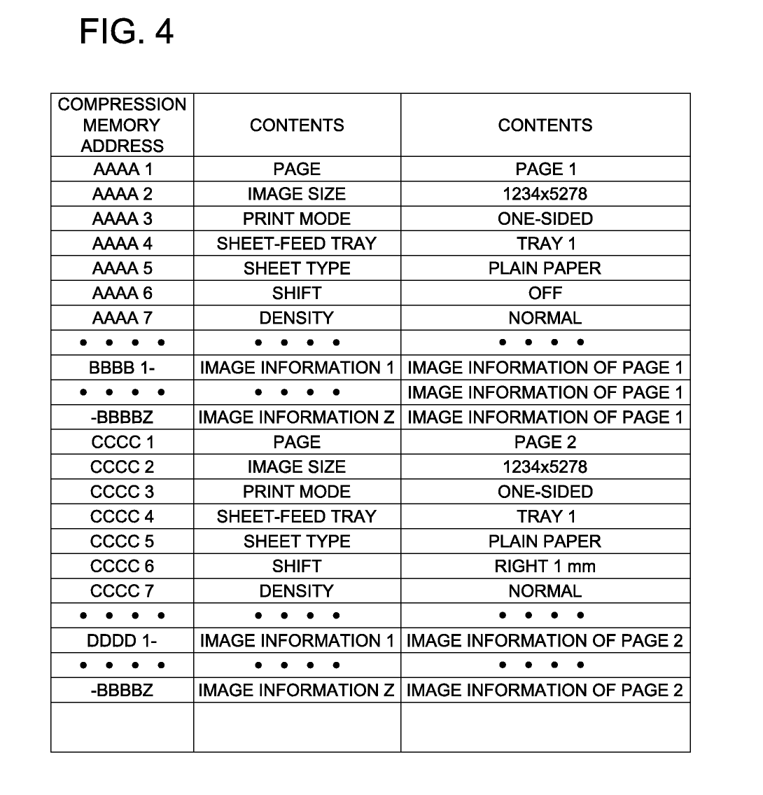

FIG. 4 is one showing an outline of the job information on compression memory 121, and outputting is carried out by image control CPU 113 based on the job information.

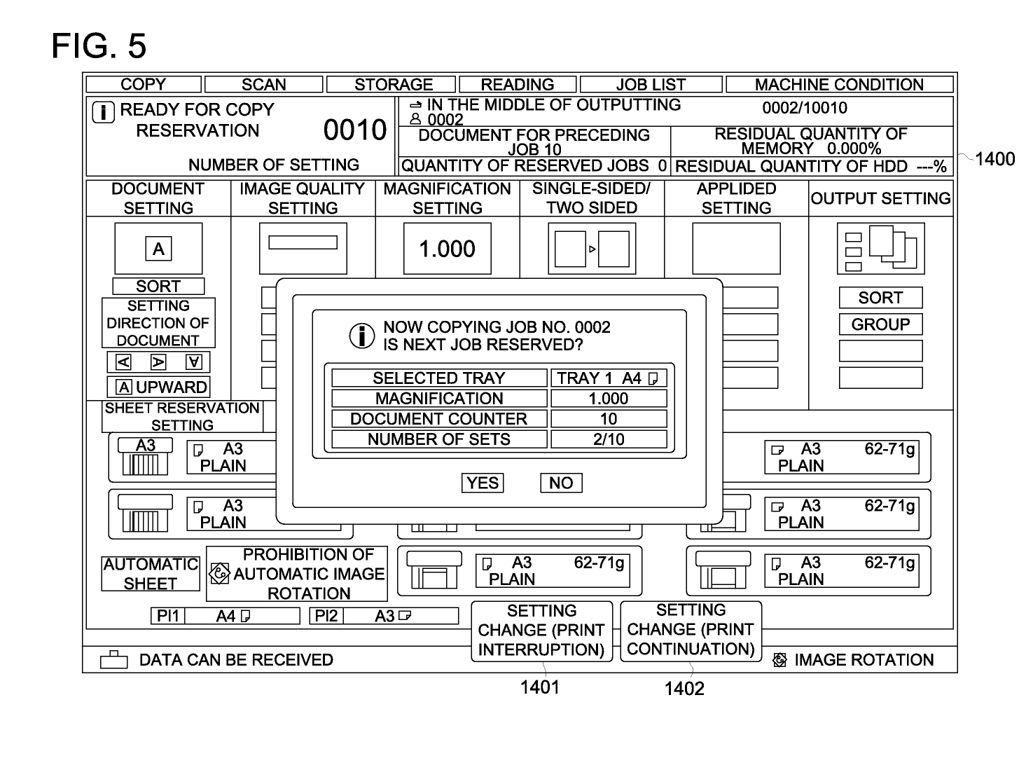

FIG. 5 is one showing an copy output screen 1400 that is displayed in the course of outputting copies in operation section 140, and the state of practicing jobs, established output conditions and an input pop-up screen for a reserved job. In the present invention, a setting change button that indicates changes of output conditions is displayed on the screen to be capable of operating and inputting, in the course of job outputting.

In the example shown in FIG. 5, setting change (print interruption) button 1401 that interrupts outputting based on setting change, and setting change (print continuation) button 1402 that continues without interrupting outputting based on setting change, are displayed to be capable of operating as a push button. Incidentally, it is also possible to arrange machine setting in advance in a way to interrupt printing or to continue printing when setting change is indicated so that the print interruption or the print continuation may be determined based on the machine setting when the setting change is indicated. Further, with respect to the machine setting, it is also possible to arrange so that the setting can be changed on the machine setting screen.

When the setting change (print interruption) button 1401 is pushed, printing is interrupted, and procedures are further carried out to conduct setting change of output conditions. On the other hand, when the setting change (print continuation) button 1402 is pushed, outputting is continued and procedures are further carried out to conduct setting change of output conditions.

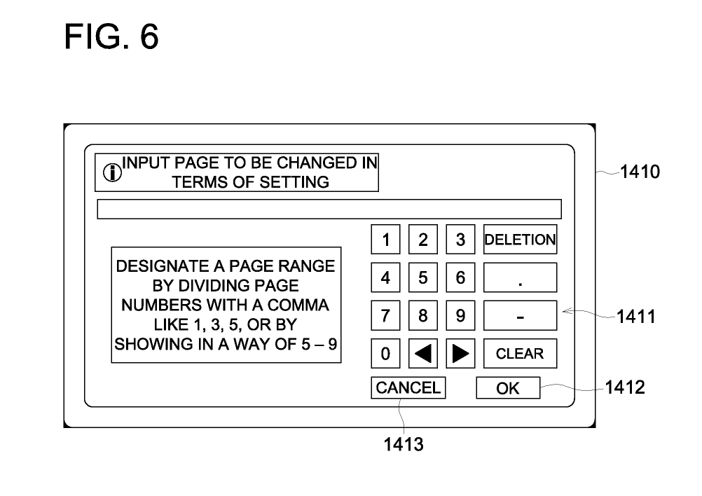

When setting change of output conditions is indicated by either one of the aforesaid push buttons, page input screen 1410 that indicates a page on which setting change is made is displayed to operation section 140 to be capable of operating and inputting, as shown in FIG. 6. The screen may either be one that is displayed to be superimposed on the aforesaid copy output screen 1400, or be one that is displayed after the screen is rewritten.

On the page input screen 1410, numeric keys 1411 for inputting pages are displayed to be capable of operating and inputting, and a page for conducting setting change of output conditions is determined by designating the page by using the numeric keys and by pushing OK button 1412. Incidentally, if cancel button 1413 is pushed, inputted page information is cancelled, thus, the page can be inputted again.

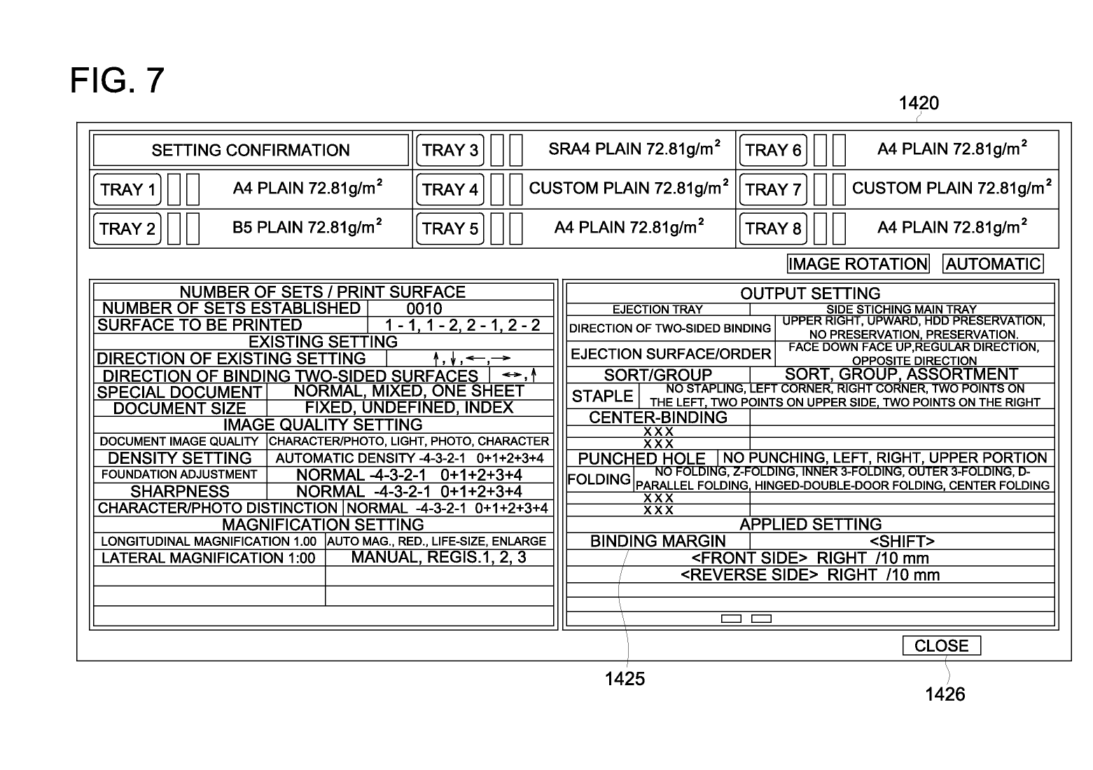

When the aforesaid OK button 1412 is pushed, output setting change screen 1420 shown in FIG. 7 is displayed on operation section 140 to be capable of operating and inputting. On the output setting change screen 1420, there are displayed established contents of output conditions for the selected page. On that screen, there are displayed established contents of the items including image quality setting, magnification setting, a sheet-ejection tray, post-processing conditions and binding margins. When items to be changed in terms of setting on the aforesaid screen are selected, setting change screens corresponding to the selected items are displayed to be capable of operating and inputting. Further, when binding button 1426 is pushed, a pop-up screen (output setting change confirming screen 1440) is displayed.

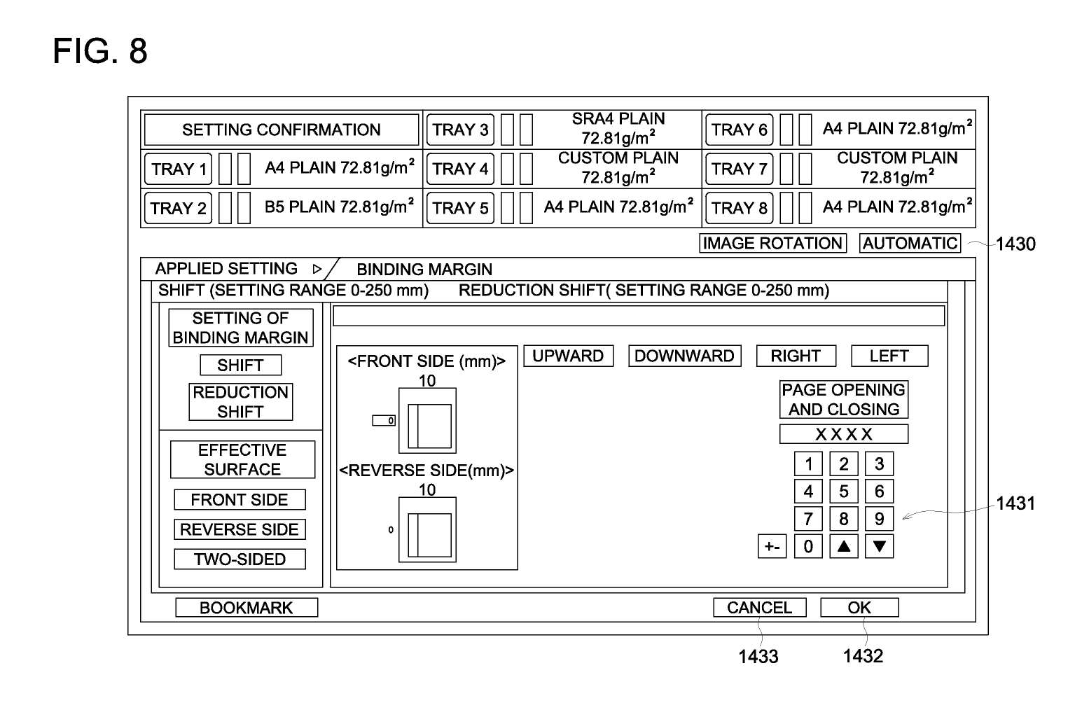

FIG. 8 is one showing detailed output setting screen 1430 that is displayed on operation section 140 when a binding margin button 1425 is pushed on output setting change screen 1420 shown in FIG. 7.

It is possible to conduct setting concerning binding margin on the detailed output setting screen 1430, and numeral keys 1431 for adjusting a width of binding margin is displayed to be capable of pushing. A width of binding margin is established by using the numeral keys 1431, and a width of the binding margin is determined by pushing OK button 1432. Incidentally, if cancel button 1433 is pushed, inputted binding margin width is deleted and that binding margin width can be inputted again.

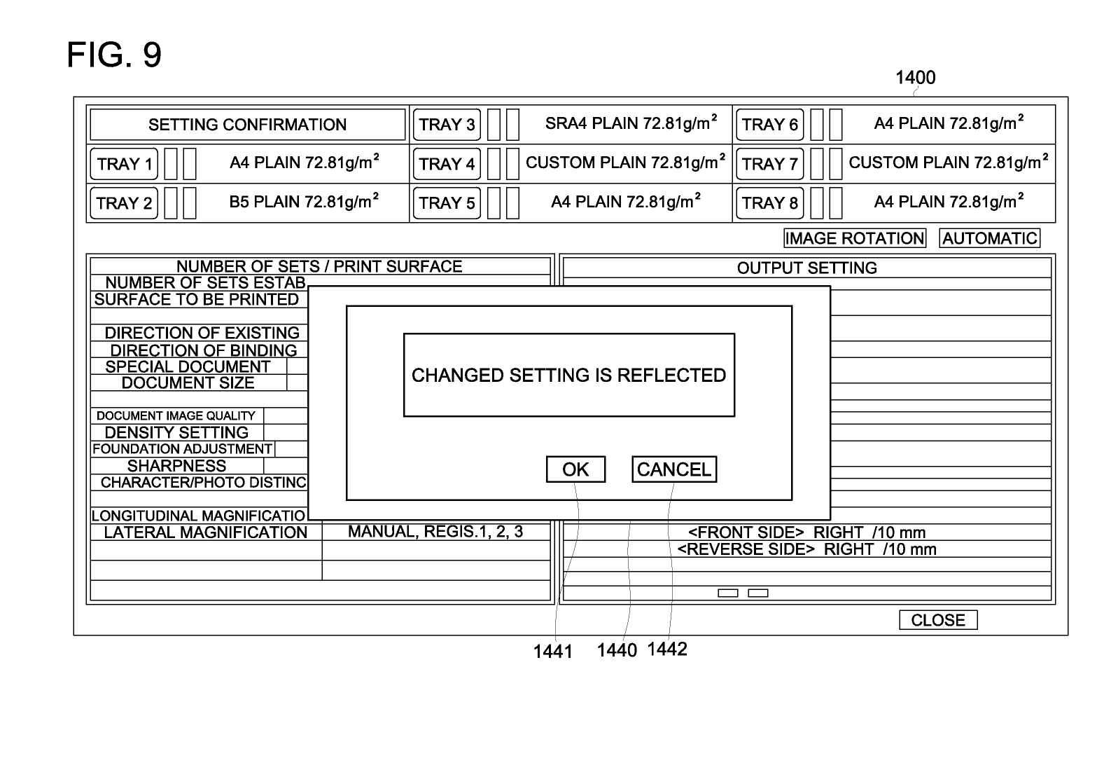

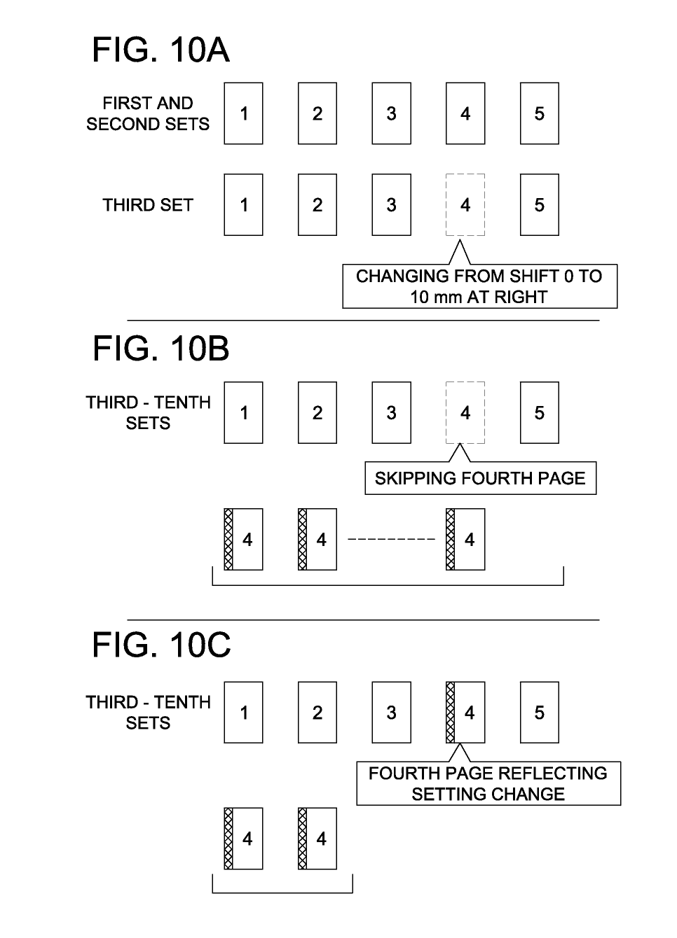

If OK button 1432 is pushed on the detailed output setting screen 1430, output setting change confirming screen 1440 is pop-up-displayed on copy output screen 1400, as shown in FIG. 9. On the output setting change confirming screen 1440, there are displayed OK button 1441 and cancel button 1442 to be capable of operating and inputting. When the OK button 1441 is pushed, contents which have been changed in terms of output setting are reflected. If the cancel button 1442 is pushed, contents of inputted output setting change are deleted, and output setting change can be inputted again.

If the OK button is pushed, an output wherein output setting change is reflected in output procedures determined in advance.

FIG. 10A is a diagram showing an outline in the occasion wherein a shift width on the fourth page was changed from 0 mm to 10 mm, on the third set in prints for jobs in 10 sets each set having 5 pages. An output method after the output setting change will be explained as follows.

In FIG. 10B, the fourth page is skipped and remaining pages are outputted in the third to tenth sets which are after the output setting change, in the aforesaid output setting change, and after that, established number of sets (10 sets) for the fourth page which have been subjected to output setting change are outputted collectively. In this case, it is desirable that established number of sets (10 sets in this case) are outputted collectively finally, after printing the third to tenth sets for which the fourth page have been skipped, for the changed fourth page. It is further desirable that prints for the changed fourth page are ejected to a sheet-ejection tray which is different from that for the outputted texts (first and second sets before the setting change and the third to tenth sets for which the fourth page after the setting change have been skipped). For example, when prints for the text are ejected to a main tray, prints for the changed fourth page are ejected to a sub-tray.

In FIG. 10C, the fourth page is replaced with one that has been subjected to the setting change, and remaining sets are outputted in the third to tenth sets which are after the output setting change, in the aforesaid setting change, and after that, the number of sets before the setting change, namely, prints for the fourth page changed for the first and second sets are outputted collectively. In this case, it is desirable that prints for the changed fourth page are outputted collectively finally, after printing the third to tenth sets. It is further desirable that the prints for the changed fourth page are ejected to a sheet-ejection tray which is different from that for the outputted texts (first and second sets before the setting change and the third to tenth sets after the setting change). For example, when the prints for the text are ejected to a main tray, the prints for the changed fourth page are ejected to a sub-tray.

Incidentally, in the foregoing, an explanation has been given under the condition that output procedures after the setting change are determined by machine setting. However, it is also possible to arrange so that the machine setting is made to be a default value which is subjected to changing operation so that output procedures can be established.

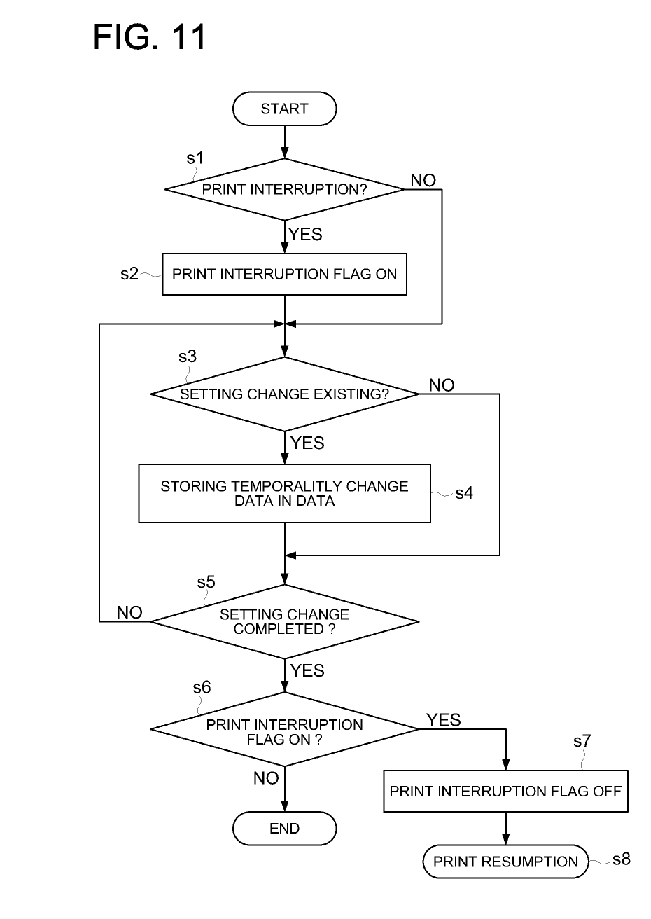

Next, procedures of the aforesaid setting change by a control section will be explained as follows, referring to the flow chart shown in FIG. 11.

The procedures are started when a setting change button is pushed. In the case of setting change, it is judged whether the setting change is carried out under print interruption or the setting change is carried out under no print interruption (step s1). When the setting change is carried out under the print interruption (step s1, YES), a print interruption flag is turned ON (step s2), while, when the setting change is carried out under no print interruption (step s1, NO), no change is made for the print interruption flag, and a step moves to step s3. In the step s3, the setting change is judged whether it is in existence or not, and if the setting change is in existence (step s3, YES), change data are stored in RAM as temporary data (step s4), and a step moves to step s5. If the setting change is not in existence (step s3, NO), the step moves to step s5 as it is.

In step s5, OK button 1441 is pushed on setting confirmation screen 1440, and it is judged whether the setting change has been completed or not. If the setting change has not been completed (step s5, NO), the step returns to step s3, and presence or absence of the setting change is confirmed. If the setting change has been completed (step s5, YES), print interruption flag is judged whether it is to be ON or not (step s6), and if the print interruption flag is not ON (step s6, NO), the procedures are completed. If the print interruption flag is ON (step s6, YES), the print interruption flag is made to be OFF (step s7), and print is resumed (step s8).

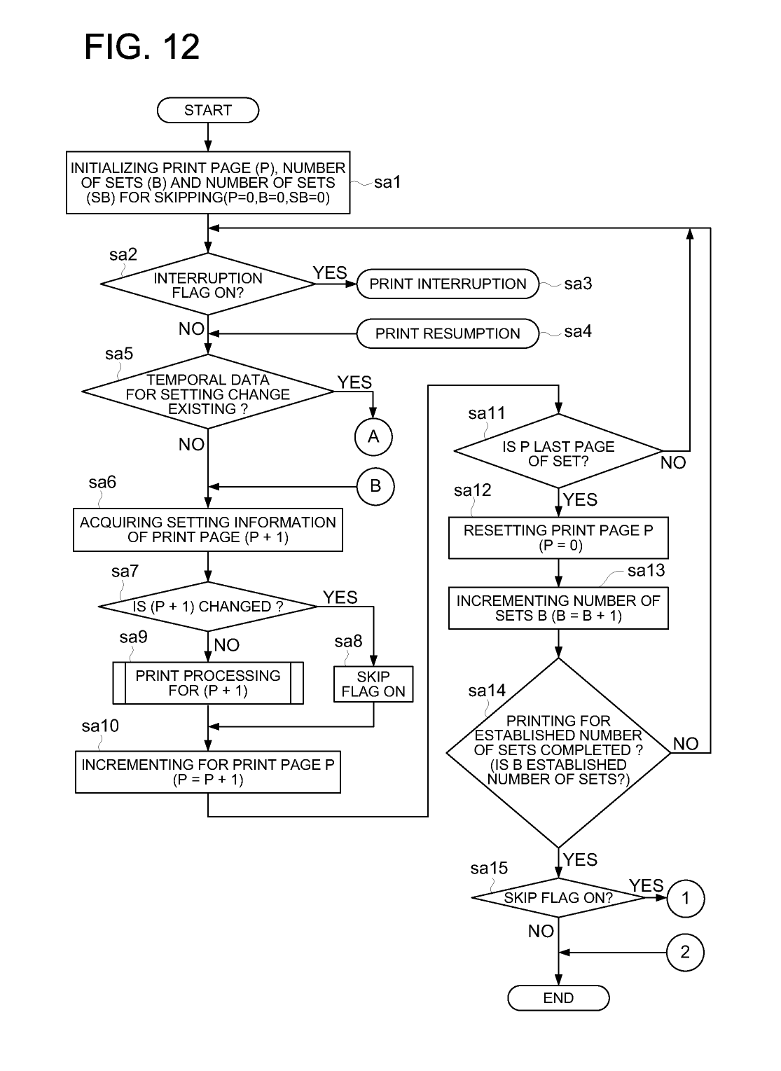

Next, procedures wherein setting is changed in the course of job output, and after the setting change, the changed pages are skipped and the changed pages in quantity of established number of sets are outputted collectively, finally will be explained as follows, referring to the flow chart shown in FIG. 12.

First, in the case of job outputting, print pages (P), number of sets for printing (B) and number of sets for skipping (SB) are initialized (step sa1). Next, the print interruption flag is judged whether it is to be ON or not (step sa2). If the print interruption flag is ON (step sa2, YES), the print is interrupted (step sa3). If the print is resumed after completion of the setting change (step sa4), the step moves to step sa5. When the print interruption flag is not ON, the step moves to step sa5 as it is.

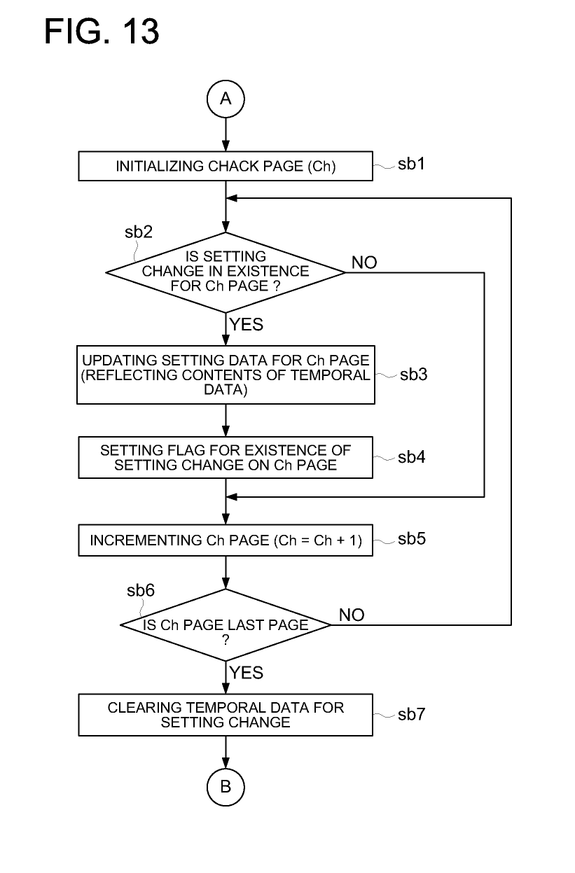

In step sa5, it is judged whether setting change temporary data are preserved or not. If the temporary data are preserved (step sa5, YES), the step moves to procedures A shown in FIG. 13. If the temporary data are not preserved, the step moves to step sa6.

In procedures A, check pages (Ch) for checking is initialized as shown in FIG. 13 (step sb1), and it is judged whether setting changes exist on check pages or not (step sb2). If the setting change is not in existence (step sb2, NO), the step moves to step sb5 where check page (Ch) which is described later is incremented. If the setting change is in existence (step sb2, YES), contents of temporary data are reflected to update the setting data of the corresponding check page (step sb3). Then, a flag showing existence of setting change is set on corresponding check page (Ch) (step sb4). After that, check page (Ch) is incremented (step sb5). Then, it is judged whether the check page (Ch) is a final page or not (step sb6). If the check page is not the final page (step sb6, NO), the step returns to step sb2, and judgment whether setting change exists or not for the incremented check page (Ch) is repeated.

If the check page (Ch) is the final page (step sb6, YES), the setting change and temporary data are cleared (step sb7), and the step returns to procedures B shown in FIG. 12.

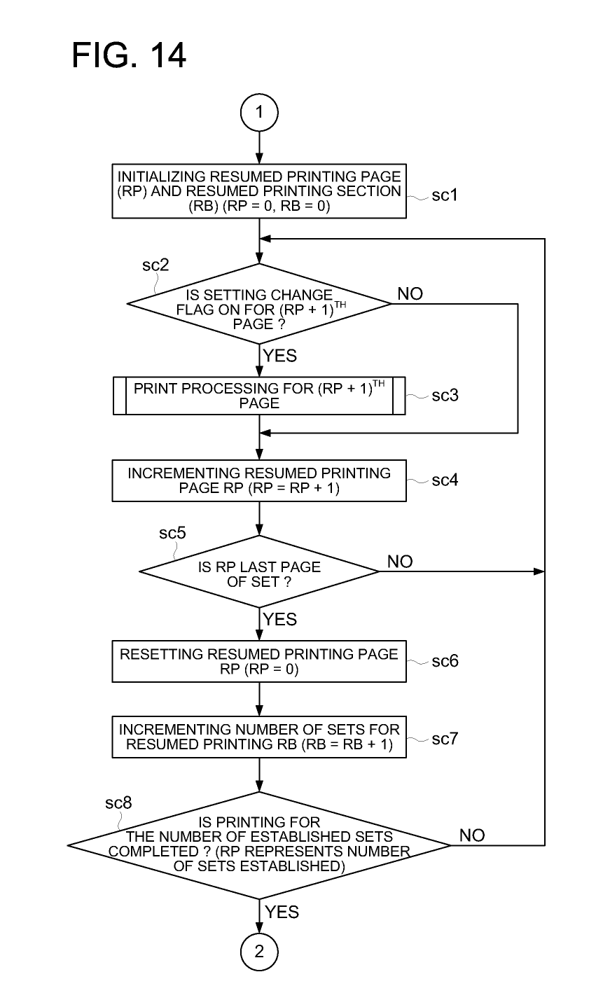

In procedures B, the step moves to step sa6 as shown in FIG. 12, and setting information for print page (P+1) is obtained. Presence or absence of a change of output setting for the corresponding page is judged by ON and OFF of a flag that represents existence of the aforesaid setting change (step sa7). If there exists a change of output setting (step sa7, YES), a skip flag is made to be ON (step sa8). Then, print page P is incremented (step sa10), and if there is no change of output setting (step sa7, NO), print processing is conducted for the corresponding page (step sa9), and after that, print page P is incremented (step sa10). After the step sa10, it is judged whether P is a final page of a set or not (step sa11). If P is not a final page (step sa11, NO), the step returns to step sa2, and procedures to judge whether setting change exists or not for the succeeding page are repeated. If P is the final page (step sa11, YES), print page P is reset (P=0) (step sa12), and number of sets for printing B are incremented (step sa13). In this case, if the skip flag is in the state of ON, the number of sets for skipping SB are also incremented. Then, it is judged whether printing for the established number of sets has been completed under B representing the established number of sets, or not (step sa14). If the printing for the established number of sets has not been completed (step sa14, NO), the step returns to step sa2, and procedures of judging whether the setting change for the next page exists or not are repeated. If the printing for the established number of sets has been completed (step sa14, YES), a skip flag is judged whether it is in the state of ON or not (step sa15). If the skip flag is not in the state of ON (step sa15, NO), the processing is completed, while, if the skip flag is in the state of ON (step sa15, YES), the step moves to procedures 1 shown in FIG. 14.

In the procedures 1, processing to output pages which have been subjected to output setting change and are after the setting change are outputted collectively, is conducted as shown in FIG. 14.

First, reprint page RP and number of sets for reprint are initialised (step sc1). Then, presence or absence of a setting change for the corresponding page (RP+1) is judged by ON and OFF of a flag that represents existence of setting change (step sc2). If there exists the setting change (step sc2, YES), print processing for the corresponding page (RP+1) is conducted (step sc3), and reprint page RP is incremented (step sc4). If there is no setting change (step sc2, NO), print processing for the corresponding page (RP+1) is not conducted, and reprint page RP is incremented (step sc4). After the step sc4, it is judged whether RP is the final page of a set or not (step sc5). If RP is not the final page (step sc5, NO), the step returns to step sc2, and procedures for judging whether the setting change exists for the next page or not are repeated. If RP is the final page (step sc5, YES), reprint page RP is reset (RP=0) (step sc6), and number of sets for reprinting RB is incremented (step sc7). Then, it is judged whether printing for the established number of sets has been completed under RB representing the established number of sets, or not (step sc8). If the printing for the established number of sets has not been completed (step sc8, NO), the step returns to step sc2, and procedures of judging whether the setting change for the next page exists or not are repeated. If the printing for the established number of sets has been completed, the step returns to procedures 2 shown in FIG. 12 to complete the processing.

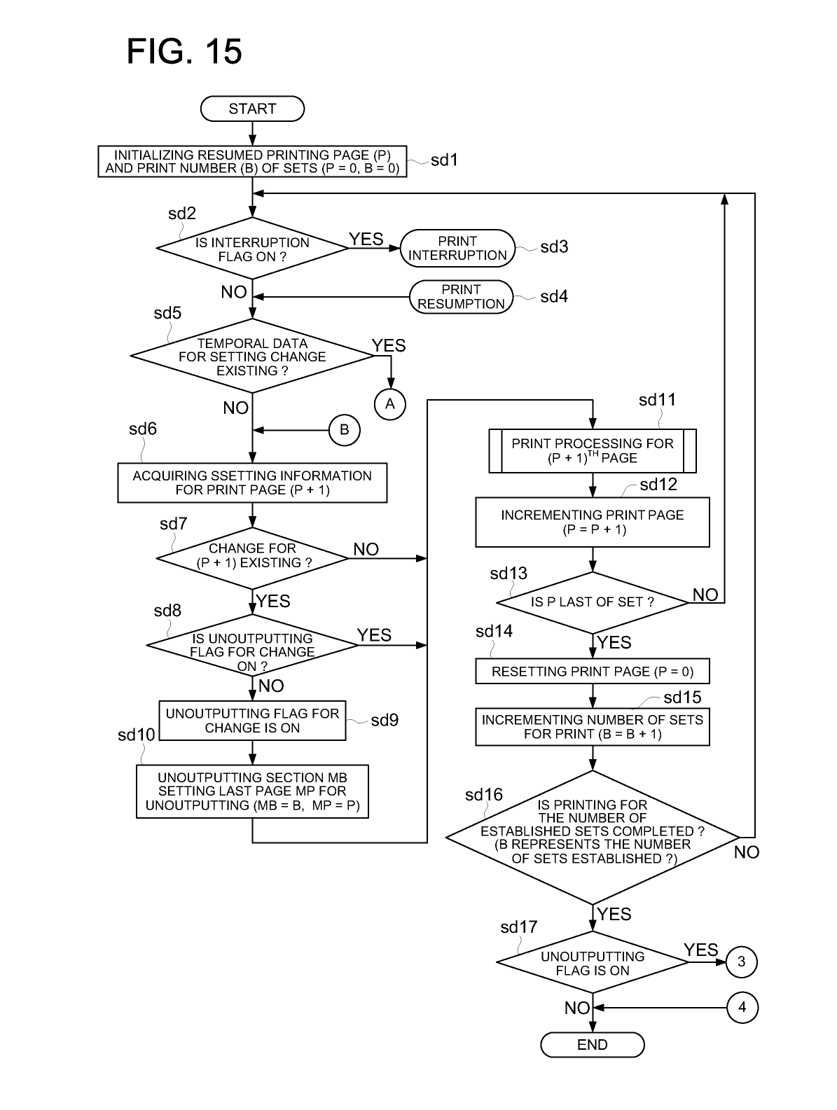

Next, procedures wherein the setting is changed in the course of outputting jobs, and after the setting change, replacing is conducted to the changed pages, and changed pages in quantity of pages before the setting change are finally outputted collectively, will be explained as follows, referring to the flow chart shown in FIG. 15.

First, in the case of outputting jobs, print pages (P) and the number of sets for printing (B) are initialized (step sd1). Next, the print interruption flag is judged whether it is to be ON or not (step sd2). If the print interruption flag is ON (step sd2, YES), the print is interrupted (step sd3). If the print is resumed after completion of the setting change (step sd4), the step moves to step sd5. When the print interruption flag is not ON (step sd2, NO), the step moves to step sd5 as it is. In the step sd5, setting change temporary data are judged whether they are preserved or not. If the temporary data are preserved (step sd5, YES), the step moves to procedures A shown in FIG. 13. If the temporary data are not preserved, the step moves to step sd6.

In the procedures A, check page (Ch) for checking is initialized (step sb1) as explained earlier, and it is judged whether the setting change exists on check page (Ch) or not (step sb2). If the setting change does not exist (step sb2, NO), the step moves to step sb5 where check page (Ch) is incremented. If the setting change exists (step sb2, YES), contents of temporary data are reflected, and the setting data for the corresponding check page (Ch) are updated (step sb3). Then, a flag that represents existence of setting change is set on the corresponding check page (Ch) (step sb4). After that, check page (Ch) is incremented (step sb5). After that, it is judged whether the check page (Ch) is a final page or not (step sb6). If the check page (Ch) is not a final page (step sb6, NO), the step returns to step sb2, and judgment to find whether setting change exists or not for the incremented check page (Ch) is repeated.

If the check page (Ch) is the final page (step sb6, YES), setting change temporary data are cleared (step sb7), and the step returns to procedures B shown in FIG. 15.

In the movement to the procedures B, the step moves to step sd6 and setting information of print page (P+1) is obtained. Based on ON and OFF of the aforesaid flag that represents existence of setting change, it is judged whether the setting change exists for the corresponding page (P+1) or not (step sd7). If the setting change exists (step sd7, YES), it is judged whether change-un-outputted flag is ON or not (step sd8), and if the change-un-outputted flag is not ON (step sd8, NO), the change-un-outputted flag is caused to be ON (step sd9). Further, B is set to un-outputted number of sets MB and P is set to un-outputted final page MP (step sd10), then, print processing is conducted for the corresponding page (P+1) (step sd11), and print page P is incremented (step sd12).

If there is no setting change in step sd7 (step sd7, NO), print processing for the corresponding page (P+1) is carried out (step sd11), and print page P is incremented (step sd12). If a change un-outputted flag is ON (step sd8, YES), print-processing for the corresponding page (P+1) is carried out (step sd11), and print page P is incremented (step sd12).

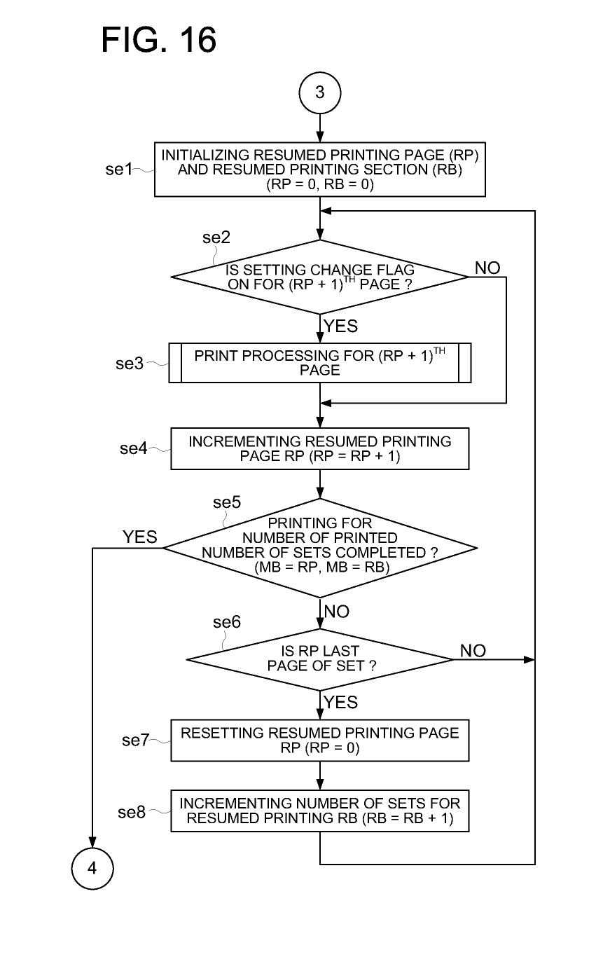

After the step sd12, it is judged whether P is a final page of a set or not (step sd13). If P is not a final page (step sd13, NO), the step returns to step sd2, and procedures to judge whether setting change exists or not for the succeeding page are repeated. If P is the final page (step sd13, YES), print page P is reset (P=0) (step sd14), and number of sets for printing B is incremented (step sd15). Then, it is judged whether printing for the established number of sets has been completed under B representing the established number of sets, or not (step sd16). If the printing for the established number of sets has not been completed (step sd16, NO), the step returns to step sd2, and procedures of judging whether the setting change for the next page exists or not are repeated. If the printing for the established number of sets has been completed (step sd16, YES), it is judged whether a change un-outputted flag is ON or not (step sd17). If the change un-outputted flag is not ON (step sd17, NO), the processing is completed, while if the change un-outputted flag is ON (step sd17, YES), the step moves to procedures 3 shown in FIG. 16.

In the procedures 3, processing to output changed pages before the setting change are outputted collectively, is conducted.

First, reprint page RP and number of sets for reprint RB are initialized (step se1). Then, presence or absence of a setting change for the corresponding page (RP+1) is judged by ON and OFF of a flag that represents existence of setting change (step se2). If there exists the setting change (step se2, YES), print processing for the corresponding page (RP+1) is conducted (step se3), and reprint page RP is incremented (step se4). If there is no setting change (step se2, NO), print processing for the corresponding page (RP+1) is not conducted, but reprint page RP is incremented (step se4). After the step se4, it is judged whether the changed pages for printed number of sets have been printed or not (step se5). If the changed pages for printed number of sets have been printed (step se5, YES), the processing is completed, and the step returns to procedures 4 shown in FIG. 15.

On the other hand, if the changed pages for printed number of sets have not been printed (step se5, NO), it is judged next whether RP is a final page of a set or not (step se6). If RP is not the final page (step se6, NO), the step returns to step se2, and procedures for judging whether the setting change exists for the next page or not are repeated. If RP is the final page (step se6, YES), reprint page RP is reset (RP=0) (step se7), and number of sets for reprint RB is incremented (step se8). Then, the step returns to step se2, and procedures for judging whether the setting change exists for the next page or not are repeated.

Through the foregoing, changed pages before the setting change are outputted collectively.

As stated above, the invention has been explained based on the aforesaid embodiments, to which, however, the invention is not limited to the contents of the aforesaid explanation, and the aforesaid embodiments can be varied suitably without departing from the spirit and scope of the invention.

As explained above, in the present embodiment, there are equipped an image forming section that forms an image based on job information, an operation section that makes operation input to be possible and a control section that controls the aforesaid image forming section and the aforesaid operation section and can establish output of the job, and the control section makes it possible to designate a part of pages by the aforesaid operation section to change the aforesaid output setting, on the half way of the job for the job in the course of outputting. Thus, the setting change for the output conditions can be carried out without spending much time and by reducing useless output as far as possible. For example, when a setting mistake is noticed in the course of outputting, it is possible to change the setting through less operation steps, and by printing again for only the pages of setting change, and by printing continuously for the pages which are free from setting change, it is possible to reduce downtime. Even for the portion that undergoes printing again, it is possible to save time for inputting jobs again.

What is claimed is:

1. An image forming apparatus comprising:
(a) an image forming section that forms an image based on job information;
(b) an operation section that enables an operator to conduct an input operation; and
(c) a controller that controls the image forming section, the operation section and a job, and is capable of conducting an output setting for the job,
wherein the controller causes the operation section to designate a part of pages of the job which is outputted in progress and to change the output setting.

2. The image forming apparatus of claim 1, wherein after the output setting is changed, the controller outputs a corresponding page on which the output setting has been changed according to the output setting after the output setting has been changed.

3. The image forming apparatus of claim 1, wherein after the output setting is changed, the controller skips an output of a corresponding page on which the output setting has been changed, and outputs residual number of sets of jobs according to an established number of sets, and then outputs collectively the established number of sets for the changed corresponding page.

4. The image forming apparatus of claim 1, wherein after the output setting is changed, the controller outputs residual number of sets of jobs by replacing with the changed corresponding page on which the output setting has been changed, and outputs collectively the corresponding page for the number of sets which have been outputted by the time that the output setting is changed after the established number of sets of the jobs are outputted.

5. The image forming apparatus of claim 3, wherein the controller outputs a page on which the output setting has been changed to a tray that is different from that for the established number of sets of the jobs which have been outputted, after the output setting is changed.

6. The image forming apparatus of claim 1, wherein the controller outputs a page on which the output setting has been changed to a tray that is different from that for a page other than a page on which the output setting has been changed, after the output setting is changed.

7. The image forming apparatus of claim 1, wherein the controller outputs the residual number of sets of jobs to a tray different from that for the number of sets which have been outputted by the time that the output setting has been changed, after the output setting is changed.

8. The image forming apparatus of claim 1, wherein the controller controls the operation section to make an input operation for changing the output setting to be possible by interrupting temporarily the output of the job when the output setting is changed.

9. The image forming apparatus of claim 8, wherein when the input operation for the change of the output setting is completed, the controller resumes the output of the job that has been interrupted temporarily.

10. The image forming apparatus of claim 1, wherein the controller controls the operation section to make an input operation for changing the output setting to be possible in parallel with the output of the job without stopping the output of the job when the output setting is changed.

11. The image forming apparatus of claim 1, wherein when the change of the output setting is selected through the operation section, the controller determines whether interrupting temporarily or continuing an output of the job, based on operation conditions established in advance when the change of the output setting is selected through the operation section.

12. The image forming apparatus of claim 1, wherein when the change of the output setting is selected through the operation section, the controller causes the operation section to be possible to select whether interrupting temporarily an output of the job or continuing the output of the job in parallel with the change of the output setting when the change of the output setting is in progress.

13. The image forming apparatus of claim 1, wherein the operation section is provided in an external equipment outside of an image forming apparatus main body.

14. The image forming apparatus of claim 13, wherein the external equipment comprises an external equipment control section which controls the operation section, and an image forming apparatus controlling section provided on the image forming apparatus main body to control the image forming section and the external equipment control section constitute the control section to work together.

15. An image forming system comprising:
(a) the image forming apparatus of claim 1; and
(b) a post-processing apparatus controlled by the control section, which conducts post processing on a sheet ejected from the image forming apparatus,
wherein the output setting for the job includes post processing conditions in the post-processing apparatus.
